(19) United States
(12) Patent Application Publication
(10) Pub. No.: US 2022/0114479 A1
(43) Pub. Date: Apr. 14, 2022

(54) SYSTEMS AND METHODS FOR AUTOMATIC MIXED-PRECISION QUANTIZATION SEARCH

(71) Applicant: Samsung Electronics Co., Ltd., Suwon-si (KR)

(72) Inventors: Changsheng Zhao, San Jose, CA (US); Yilin Shen, Santa Clara, CA (US); Hongxia Jin, San Jose, CA (US)

(21) Appl. No.: 17/090,542

(22) Filed: Nov. 5, 2020

Related U.S. Application Data
(60) Provisional application No. 63/091,690, filed on Oct. 14, 2020.

(51) Int. Cl. G06N 20/00; G06N 7/00; G06N 5/04

(52) U.S. Cl. CPC G06N 20/00; G06N 5/04; G06N 7/005

(57) ABSTRACT

A machine learning method using a trained machine learning model residing on an electronic device includes receiving an inference request by the electronic device. The method also includes determining, using the trained machine learning model, an inference result for the inference request using a selected inference path in the trained machine learning model. The selected inference path is selected based on a highest probability for each layer of the trained machine learning model. A size of the trained machine learning model is reduced corresponding to constraints imposed by the electronic device. The method further includes executing an action in response to the inference result.

### CROSS-REFERENCE TO RELATED APPLICATION AND PRIORITY CLAIM

This application claims priority under 35 U.S.C. § 119(e) to U.S. Provisional Patent Application No. 63/091,690 filed on Oct. 14, 2020, which is hereby incorporated by reference in its entirety.

### TECHNICAL FIELD

This disclosure relates generally to machine learning systems. More specifically, this disclosure relates to systems and methods for automatic mixed-precision quantization searching.

### BACKGROUND

It is increasingly common for service providers to run artificial intelligence (AI) models locally on user devices to avoid user data collection and communication costs. However, executing AI models can be resource-intensive, and the efficiency of both an AI model and a user device can be significantly impacted by on-device execution of the AI model. Transformer-based architectures, such as Embeddings from Language Models (ELMo), Generative Pre-trained Transformer 2 (GPT-2), and Bidirectional Encoder Representations from Transformers (BERT), have achieved improvements over traditional models in the performance of various AI tasks, such as Natural Language Processing (NLP) and Natural Language Understanding (NLU) tasks. Although transformer-based models have achieved a certain level of accuracy on tasks like NLU or question answering, transformer-based models can still contain millions or even billions of parameters, which results in high latency and large memory usage. Due to these limitations, it is often impractical to deploy such large models on resource-constrained devices with tight power budgets.

### SUMMARY

This disclosure provides systems and methods for automatic mixed-precision quantization searching.

In a first embodiment, a machine learning method using a trained machine learning model residing on an electronic device includes receiving an inference request by the electronic device. The method also includes determining, using the trained machine learning model, an inference result for the inference request using a selected inference path in the trained machine learning model. The selected inference path is selected based on a highest probability for each layer of the trained machine learning model. A size of the trained machine learning model is reduced corresponding to constraints imposed by the electronic device. The method further includes executing an action in response to the inference result.

In a second embodiment, an electronic device includes at least one memory configured to store a trained machine learning model. The electronic device also includes at least one processor coupled to the at least one memory. The at least one processor is configured to receive an inference request. The at least one processor is also configured to determine, using the trained machine learning model, an inference result for the inference request using a selected inference path in the trained machine learning model. The selected inference path is selected based on a highest probability for each layer of the trained machine learning model. A size of the trained machine learning model is reduced corresponding to constraints imposed by the electronic device. The at least one processor is further configured to execute an action in response to the inference result.

In a third embodiment, a non-transitory computer readable medium embodies a computer program. The computer program includes instructions that when executed cause at least one processor of an electronic device to receive an inference request. The computer program also includes instructions that when executed cause the at least one processor to determine, using a trained machine learning model, an inference result for the inference request using a selected inference path in the trained machine learning model. The selected inference path is selected based on a highest probability for each layer of the trained machine learning model. A size of the trained machine learning model is reduced corresponding to constraints imposed by the electronic device. The computer program further includes instructions that when executed cause the at least one processor to execute an action in response to the inference result.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration in accordance with various embodiments of this disclosure;

FIG. 2 illustrates an example artificial intelligence model training and deployment process in accordance with various embodiments of this disclosure;

FIG. 3 illustrates an example architecture model in accordance with various embodiments of this disclosure;

FIG. 4 illustrates a model architecture training process in accordance with various embodiments of this disclosure;

FIGS. 5A and 5B illustrate an example quantization and pruning process in accordance with various embodiments of this disclosure;

FIG. 6 illustrates an example two-bit quantization method in accordance with various embodiments of this disclosure;

FIG. 7 illustrates an example eight-bit quantization method in accordance with various embodiments of this disclosure;

FIG. 8 illustrates an example mixed bit quantization and pruning method in accordance with various embodiments of this disclosure;

FIG. 9 illustrates an example architecture searching model in accordance with various embodiments of this disclosure;

FIGS. 10A and 10B illustrate an example quantization and architecture searching and training process and an example trained model inference process in accordance with various embodiments of this disclosure;

FIGS. 11A and 11B illustrate an example model training process in accordance with various embodiments of this disclosure; and

FIG. 12 illustrates an example model inference process in accordance with various embodiments of this disclosure.

### DETAILED DESCRIPTION

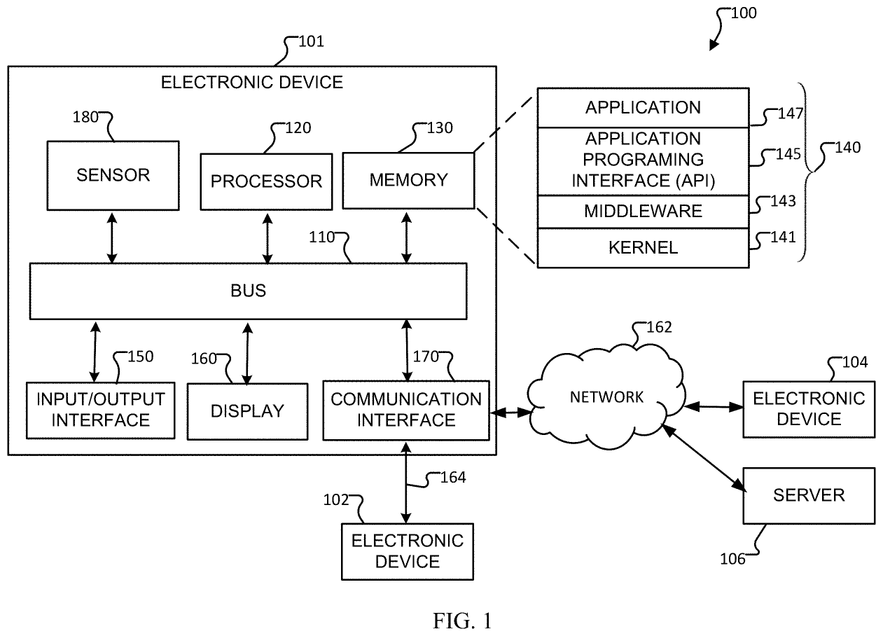

FIGS. 1 through 12, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

Performing on-device artificial intelligence (AI) inferences allows for convenient and efficient AI services to be performed on user devices, such as providing natural language recognition for texting or searching services, image recognition services for images captured using the user devices, or other AI services. To provide on-device AI inferences, a model owner can deploy a model onto a user device, such as via an AI service installed on the user device. A client, such as an installed application on the user device, can request an inference from the AI service, such as a request to perform image recognition on an image captured by the user device or a request to perform Natural Language Understanding (NLU) on an utterance received from a user. The AI service can receive inference results from the model and execute an action on the user device. However, executing AI models can be resource-intensive, and the efficiency of both an AI model and a user device can be significantly impacted by on-device execution of the AI model.

Transformer-based models have provided improvements in the performance of various AI tasks. However, while transformer-based models have achieved a certain level of accuracy on tasks like NLU or question answering, transformer-based models can still contain millions or even billions of parameters, which results in high latency and large memory usage. Due to these limitations, it is often impractical to deploy such large models on resource-constrained devices with tight power budgets. Knowledge distillation, weight pruning, and quantization can provide model compression, but many approaches aim to obtain a compact model through knowledge distillation from the original larger model, which may suffer from significant accuracy reductions even for a relatively small compression ratio.

Quantization provides a universal and model-independent technique that can significantly lower inference times and memory usages. By replacing a floating point weight with an integer, memory usage can be reduced by four times that of using floating point weights. Moreover, integer arithmetic is far more efficient on modern processors, which can greatly reduce inference time. Using an extreme low number of bits to represent a model weight can further optimize memory usage. However, in some cases, there can be problems with finding an optimal bit allocation for the size and latency constraints for a particular downstream task.

This disclosure provides systems and methods for automatic mixed-precision quantization searching. The systems and methods provide for optimizing and compressing an artificial intelligence or other machine learning model using quantization and pruning of the model in conjunction with searching for the most efficient paths of the model to use at runtime based on prioritized constraints of an electronic device. The systems and methods disclosed here can greatly reduce the size of a machine learning model, as well as the speed of processing inferences performed using the machine learning model.

Various embodiments of this disclosure include a Bidirectional Encoder Representations from Transformers (BERT) compression approach or other approach that can achieve automatic mixed-precision quantization, which can conduct quantization and pruning at the same time. For example, various embodiments of this disclosure leverage a differentiable Neural Architecture Search (NAS) to automatically assign scales and precisions for parameters in each sub-group of model parameters for a machine learning model while pruning out redundant groups of parameters without additional human efforts involved. Beyond layer-level quantization, various embodiments of this disclosure include a group-wise quantization scheme where, within each layer, different scales and precisions can be automatically set for each neuron sub-group. Some embodiments of this disclosure also provide the possibility to obtain an extremely light-weight model by combining the previously-described solution with orthogonal techniques, such as DistilBERT.

FIG. 1 illustrates an example network configuration 100 in accordance with various embodiments of this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more of a central processing unit (CPU), a graphics processor unit (GPU), an application processor (AP), or a communication processor (CP). The processor 120 is able to perform control on at least one of the other components of the electronic device 101 and/or perform an operation or data processing relating to communication. In accordance with various embodiments of this disclosure, the processor 120 can train or further optimize at least one trained machine learning model to allow for selection of inference paths within the model(s) based on a highest probability for each layer of the model(s). The processor 120 can also reduce the size of the model(s) based on constraints of the electronic device 101. In some embodiments, at least certain portions of training the model(s) are performed by one or more processors of another electronic device, such as a server 106. Once the model or models are trained and/or optimized, the processor 120 can execute the appropriate machine learning model(s) when an inference request is received in order to determine an inference result using the model(s), and the processor 120 can use a selected inference path in the model(s).

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS). As described below, the memory 130 can store at least one machine learning model for use during processing of inference requests. In some embodiments, the memory 130 may represent an external memory used by one or more machine learning models, which may be stored on the electronic device 101, an electronic device 102, an electronic device 104, or the server 106.

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 can include at least one application that receives an inference request, such as an utterance, an image, a data prediction, or other request. The application 147 can also include an AI service that processes AI inference requests from other applications on the electronic device 101. The application 147 can further include machine learning application processes, such as processes for managing configurations of AI models, storing AI models, and/or executing one or more portions of AI models.

The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control. In some embodiments, the API 145 includes functions for requesting or receiving AI models from at least one outside source.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals, such as signals received by the communication interface 170 regarding AI models provided to or stored on the electronic device 101.

The wireless communication is able to use at least one of, for example, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a cellular communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

The first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more cameras. As disclosed in various embodiments of this disclosure, optimization of machine learning models and constraints used in such optimizations can differ depending on the device type of the electronic device 101, such as whether the electronic device 101 is a wearable device or a smartphone.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. In some embodiments, the server 106 may be used to train or optimize one or more machine learning models for use by the electronic device 101.

Although FIG. 1 illustrates one example of a network configuration 100, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

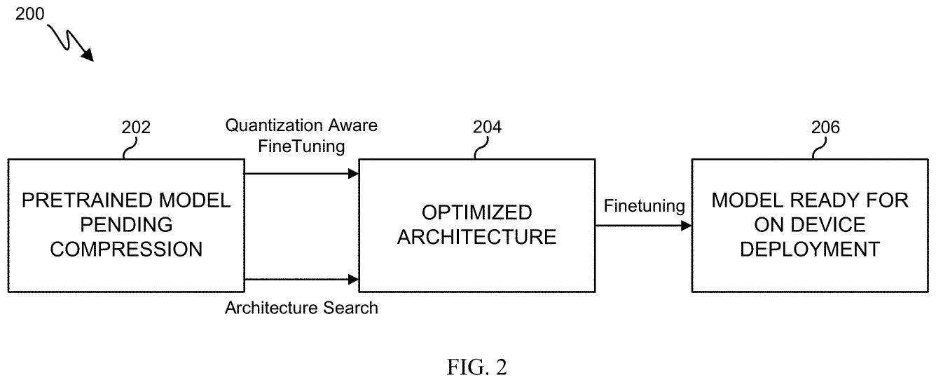

FIG. 2 illustrates an example artificial intelligence model training and deployment process 200 in accordance with various embodiments of this disclosure. For ease of explanation, the model training and deployment process 200 of FIG. 2 is described as being performed using components of the network configuration 100 of FIG. 1. However, the model training and deployment process 200 may be used with any suitable device(s) and in any suitable system(s).

As shown in FIG. 2, the process 200 includes obtaining a pretrained model 202 that, in some embodiments, is trained to perform a particular machine learning function, such as one or more NLU tasks or image recognition tasks. The pretrained model 202 is further optimized and compressed by performing quantization aware finetuning and an architecture search. As described in the various embodiments of this disclosure, quantization aware finetuning includes performing quantization on model parameters and/or pruning of model parameters or nodes. Performing quantization and pruning on the pretrained model 202 decreases memory usage and increases inference speed with minimal loss in accuracy. Performing the architecture search further increases the efficiency of the pretrained model 202. Architecture searching includes determining which edges of the model 202 to choose between nodes of the model 202. For example, different edges of the model 202 between nodes can have particular bits assigned to use for those edges during quantization, and performing the architecture search can involve determining which edge (and its associated quantization bit) provide the most accurate results.

Performing quantization aware finetuning and architecture searching on the pretrained model 202 provides an optimized model architecture 204. The optimized model architecture 204, as a result of the quantization aware finetuning and architecture searching, is a quantized and/or compressed architecture that is smaller in size and provides for increased inference calculation speeds. In some cases, the optimized architecture 204 can be more than eight times smaller than the size of the pretrained model 202 and can process inferences at least eight times faster than the pretrained model 202. The optimized architecture 204 can be further finetuned to provide a final model 206 that is ready for on-device deployment. Finetuning the optimized architecture 204 can include applying customized constraints for the device(s) that will store and execute the final model 206, such as size constraints, inference speed constraints, and accuracy constraints. In some embodiments, the constraints are included as part of a loss function used during training, optimization, and/or finetuning.

Although FIG. 2 illustrates one example of an artificial intelligence model training and deployment process 200, various changes may be made to FIG. 2. For example, the finetuning performed on the optimized architecture 204 can be performed subsequent to performing the quantization aware finetuning and architecture search, or the finetuning can be integrated into the quantization aware finetuning and architecture search. Also, the pretrained model 202, optimized architecture 204, and final model 206 can each be stored, processed, or used by any suitable device(s), such as the electronic device 101, 102, or the server 106. For instance, the pretrained model 202 may be stored on the server 106, the optimized architecture 204 and the final model 206 may be created on the server 106, and the final model 206 may be provided to and stored on an electronic device, such as the electronic device 101. At that point, the electronic device 101 may store the final model 206 in the memory 130 and execute the final model 206 to process inference requests. In other embodiments, the pretrained model 202 may be provided to a device, such as the electronic device 101, and the electronic device can optimize and finetune the pretrained model 202 to create the optimized architecture 204 and the final model 206. In addition, model architectures can come in a wide variety of configurations, and FIG. 2 does not limit the scope of this disclosure to any particular configuration.

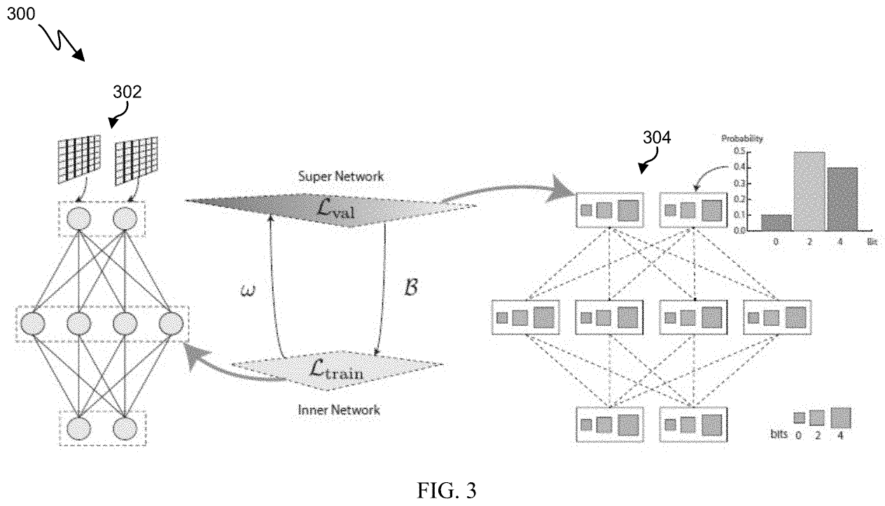

FIG. 3 illustrates an example architecture model 300 in accordance with various embodiments of this disclosure. For ease of explanation, the model 300 may be described as being executed or otherwise used by the processor(s) of any of the electronic devices 101, 102, 104 or the server 106 in FIG. 1. However, the model 300 may be used with any suitable device(s) and in any suitable system(s).

Given a large model M, one goal is to obtain a compact model M′ with desirable size Vby automatically learning the optimal bit assignment set O*and weight set ω* However, achieving this goal presents a number of challenges, such as finding the best bit assignment automatically, performing pruning and quantization simultaneously, compressing the model to a desirable size, achieving back propagation when bit assignments are discrete operations, and efficiently inferring parameters for a bit assignment set and a weight set together.

As shown in FIG. 3, the model 300 includes an inner training network 302 and a super network 304. The inner training network 302 trains weights of the model 300, and the super network 304 controls bit assignments. In some embodiments, the inner training network 302 represents a matrix or group of neurons, which can be referred to as a subgroup. Each subgroup can include its own quantization range in a mixed-precision setting. As shown with respect to the super network 304, in this example, a subgroup has three choices for bit assignment: zero-bit, two-bit, and four-bit. As described in the various embodiments of this disclosure, each bit assignment is associated with a probability of being selected.

In some embodiments, the inner training network 302 can be considered like a neural network that optimizes weights, except that each node represents a subgroup of neurons rather than a single neuron. As illustrated with respect to the super network 304, for a subgroup j in layer i, there could be K different choices of precision, and the k^{th} choice is denoted as bₖ^{i,j}. For example, in FIG. 3, as each subgroups has three choices of bit-width (zero-bit, two-bit, and four-bit), the probability of choosing a certain precision is denoted as pₖ^{i,j}, and the bit assignment can be a one-hot variable Oₖ^{i,j} such that Σₖpₖ^{i,j}=1, and one precision is selected at a time.

In some embodiments, the processor using the model 300 jointly learns the bit assignments O and the weights w within mixed operations. Also, in some embodiments, the processor (via the super network 304) updates the bit assignment set O by calculating a validation loss function [symbol] ᵥₐₗ, and the processor (via the inner training network 302) optimizes the weights set w through a loss function [symbol] ₜᵣₐᵢₙ based on the cross-entropy. This two-stage optimization framework provided by the model 300 enables the processor to perform automatic searching for the bit assignments.

In some embodiments, the processor using the model 300 may jointly optimize the bit assignment set O and weight set ω. Both the validation loss [symbol] ᵥₐₗ and the training loss [symbol] ₜᵣₐᵢₙ are determined by the bit assignment O and the weights w in the model 300. A possible goal for bit assignment searching is to find the optimal bit assignment O* that minimizes the validation loss [symbol] ᵥₐₗ (ω*_{P}, O), where the optimal weight set w* associated with the bit assignments is obtained by minimizing the training loss [symbol] ₜᵣₐᵢₙ(O*, ω). In this two-level optimization process, the bit assignment set 0 is an upper-level variable and the weight set w is a lower-level variable such that:

$$\begin{matrix}{min}_{O} {ℒ}_{val} ( {ω}^{*} , 𝒪 ) & ( 1 ) \\ s . t . {ω}^{*} = arg {min}_{ω} {ℒ}_{train} ( ω , 𝒪 ) & ( 2 )\end{matrix}$$

The training loss [symbol] ₜᵣₐᵢₙ(O*, ω) is a cross-entropy loss, and the validation loss [symbol] ᵥₐₗ includes both classification loss and a penalty for the model size such that:

$${ℒ}_{val} = - log \frac{exp ( {ψ}_{y} )}{{\sum }_{j = 1}^{\vert ψ \vert} exp ( {ψ}_{y} )} + λ {ℒ}_{size} \qquad ( 3 )$$

where ψ_{y} is the output logits of the network, y is the ground truth class, and λ is the weight penalty.

In some embodiments, the processor can configure the model size through the penalty [symbol] _{size}, thereby encouraging the computational cost of the network to converge to a desirable size V. For instance, the computation cost [symbol] _{size} may be calculated as follows:

$$\begin{matrix}{ℒ}_{size} = \{ \begin{matrix}log 𝔼 [ {C}_{𝒪} ] & & {C}_{𝒪} > ( 1 + ϵ ) \times \\ 0 & {C}_{𝒪} & ∈ [ ( 1 - ɛ ) \times , ( 1 + ϵ ) \times ] \\ - log 𝔼 [ {C}_{𝒪} ] & & {C}_{𝒪} < ( 1 - ϵ ) \times \end{matrix} \} & ( 4 ) \\ {C}_{𝒪} = {\sum }_{i , j} {\sum }_{k} ‖ {b}_{k}^{i , j} \cdot {O}_{k}^{i , j} ‖ 2 & ( 5 ) \\ 𝔼 [ {C}_{𝒪} ] = {\sum }_{i , j} {\sum }_{k} {p}_{k}^{i , j} ‖ {b}_{k}^{i , j} \cdot {O}_{k}^{i , j} ‖ 2 & ( 6 )\end{matrix}$$

where [symbol] is the actual size of the model with bit assignment O (which is a group Lasso regularizer), [symbol] is the weighted average of the current size, pₖ^{i,j} is the respective weight probability for each bit, bₖ^{i,j} represents the bit values (such as 0, 1, 2, 3, 4, . . . , 8), V is the target size for the model (such as 20 MB, 30 MB, etc.), and Oₖ^{i,j} is a one-hot vector to control whether to include a particular bit in the search space. For example, the search space may be limited to a range such as [0,4].

For a subgroup j on layer i, there is a possibility that the optimal bit assignment is zero. In this case, the bit assignment is equivalent to a pruning that removes this subgroup of neurons from the network. A toleration rate ϵ∈[0,1] may be used to restrict the variation of model size around the desirable size V. [symbol] is the expectation of the size cost [symbol] , where the weight is the bit assignment probability. The validation loss [symbol] ᵥₐₗ configures the model size according to a user-specified size value V, such as through piece-wise cost computation, and provides a possibility to achieve quantization and pruning together, such as via the group Lasso regularizer.

Traditionally, weights in a neural network are represented by 32-bit full-precision floating point numbers. Quantization is a process that converts full-precision weights to fixed-point numbers or integers with lower bit-width, such as two, four, or eight bits. In mixed-precision quantization, different groups of neurons can be represented by different quantization ranges, meaning different numbers of bits. To map floating point values to integer values, if the original floating point subgroup in the network is denoted by matrix A and the number of bits used for quantization is b, the processor can calculate the scale factor q_{A}∈ [symbol] ⁺ as follows:

$${q}_{A} = \frac{{2}^{b} - 1}{max ( A ) - min ( A )} \qquad ( 7 )$$

The processor can estimate a floating point element a∈A by the scale factor and its quantizer Q(a) such that a≈Q(a)/q_{A}. A uniform quantization function may be used to evenly split the range of the floating point tensor, such as in the following manner:

$$Q ( a ) = round ( {q}_{A} \cdot [ a - min ( A ) ] ) \qquad ( 8 )$$

The quantization function may be non-differentiable and represent a straight-through estimator (STE) that can be used to back propagate a gradient. This can be viewed as an operator that has arbitrary forward and backward operations, such as:

$$\begin{matrix}Forward \text{:} \hat{ω} = Q ( {ω}_{A} ) / {q}_{ω A} & ( 9 ) \\ Backward \text{:} \frac{\partial {ℒ}_{train}}{\partial {\hat{ω}}_{A}} = \frac{\partial {ℒ}_{train}}{\partial {ω}_{A}} & ( 10 )\end{matrix}$$

Here, the processor can convert real-value weights ω_{A} into quantized weights \hat{ω} during a forward pass calculated using Equations (7) and (8). In the backward pass, the gradient can be used to approximate the true gradient of ω by STE.

Mixed-precision assignment operations are discrete variables, which are non-differentiable and unable to be optimized through gradient descent. In some embodiments, the processor can use a concrete distribution to relax the discrete assignments, such as by using Gumbel-softmax. This can be expressed as:

$${O}_{k}^{i , j} = \frac{exp ( ( log {β}_{k}^{i , j} + {g}_{k}^{i , j} ) / t )}{{\sum }_{k} exp ( ( log {β}_{k}^{i , j} + {g}_{k}^{i , j} ) / t )} \\ s . t . {g}_{k}^{i , j} = - log ( - log ( u ) ) , u ∼ U ( 0 , 1 ) \qquad ( 11 )$$

where t is the softmax temperature that controls the samples of Gumbel-softmax and β is the parameter that determined the bit assignments for each path. As t→∞, Oₖ^{i,j} is close to a continuous variable following a uniform distribution. As t→0, the values of Oₖ^{i,j} tend to be a one-shot variable following the categorical distribution. In some embodiments, the processor uses an exponential decaying schedule to anneal the temperature, as follows:

$$t = {t}_{0} \cdot exp ( - η x ( epoch - {N}_{0} ) ) \qquad ( 12 )$$

where t₀ is the initial temperature, N₀ is the number of warm up epoch, and the current temperature decays exponentially after each epoch.

Although FIG. 3 illustrates one example architecture model 300, various changes may be made to FIG. 3. For example, the model 300 can include any number of nodes and any number of edges between the nodes. The model 300 can also use different bit values for the super network 304, such as six-bit, eight-bit, or sixteen-bit values. In addition, architecture models can come in a wide variety of configurations, and FIG. 3 does not limit the scope of this disclosure to any particular configuration of a machine learning model.

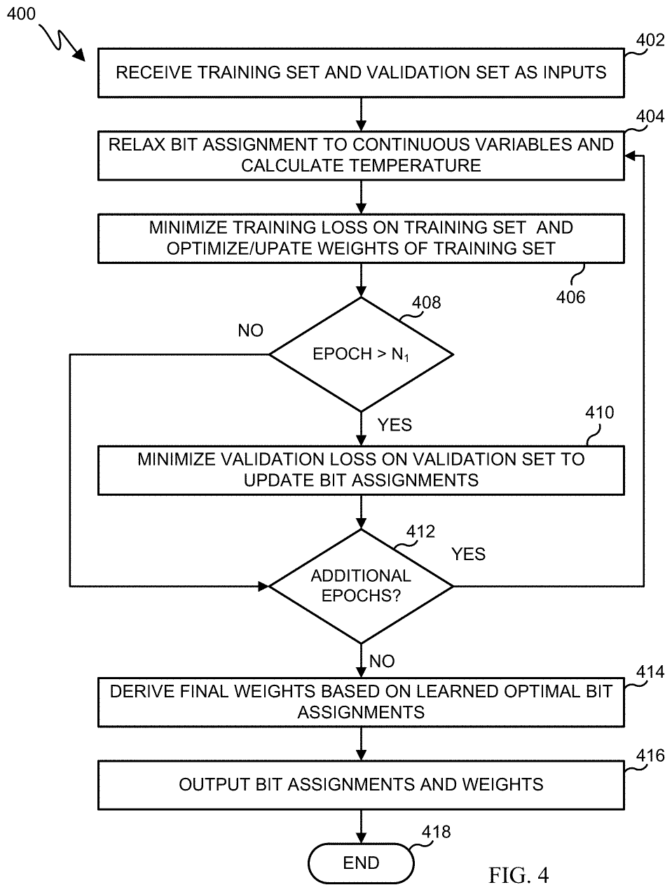

FIG. 4 illustrates an example model architecture training process 400 in accordance with various embodiments of this disclosure. For ease of explanation, the process 400 may be described as being executed or otherwise used by the processor(s) of any of the electronic devices 101, 102, 104 or the server 106 in FIG. 1. However, the process 400 may be used by any suitable device(s) and in any suitable system(s). Also, in some embodiments, the process 400 can be used with the model 300, although other models may be used with the process 400.

The optimizations of the two-level variables in the model 300 are non-trivial due to the large amount of computations. In some cases, the processor can optimize the two-level variables alternately such that the processor infers one set of parameters while fixing the other set of parameters. However, this can be computationally expensive. Thus, in other embodiments, the processor can adopt a faster inference and simultaneously learn variables of different levels. Here, the validation loss [symbol] ᵥₐₗ is determined by both the lower-level variable weights ω and the upper-level variable bit assignments O. In FIG. 4, the process 400 includes using the following:

$${∇}_{𝒪} {ℒ}_{val} ( {ω}^{*} , 𝒪 ) \\ \approx {∇}_{𝒪} {ℒ}_{val} ( ω - ξ {∇}_{ω} {ℒ}_{train} , 𝒪 ) \qquad \begin{matrix}( 13 ) \\ ( 14 )\end{matrix}$$

In some embodiments, the hyper-parameter set O is not kept fixed during the training process of the inner optimization related to Equation (2), and it is possible to change the hyper-parameter set O during the training of the inner optimization. Specifically, as shown in Equation (14), the approximation ω* can be achieved by adapting one single training step ω−ξ∇_{ω} [symbol] ₜᵣₐᵢₙ. If the inner optimization already reaches a local optimum (∇_{ω} [symbol] ₜᵣₐᵢₙ→0), Equation (14) can be further reduced to [symbol] ᵥₐₗ(ω, [symbol] ). Although convergence is not guaranteed in theory, the process 400 observes that the optimization is able to reach a fixed point in practice.

At block 402, the processor receives a training set [symbol] _{Train} and a validation set [symbol] ᵥₐₗ as inputs to a model, such as the model 300. At block 404, the processor relaxes the bit assignments to continuous variables, such as by using Equation (11), and calculates the softmax temperature t, such as by using Equation (12). After block 404, both the weights and bit assignments are differentiable. At block 406, the processor calculates or minimizes the training loss Lₜᵣₐᵢₙ on the training set [symbol] _{Train} to optimize the weights.

At decision block 408, the processor determines if the current epoch is greater than N₁ (where epoch=0, . . . , N), where N is dependent on the dataset and chosen empirically to be about 1/10 of the total number of epochs. If so, the process 400 moves to block 410. If not, the process 400 moves to decision block 412. At block 410, to ensure that weights are sufficiently trained before the processor updates the bit assignments, the processor delays the training of the validation loss [symbol] ᵥₐₗ on the validation set [symbol] ᵥₐₗ for N₁ epochs. Once at block 410, the processor minimizes the validation loss [symbol] ᵥₐₗ on the validation set [symbol] ᵥₐₗ, such as by using Equation (14). For each subgroup, the number of bits with maximum probability is chosen as the bit assignment. The process then moves to decision block 412. At decision block 412, the processor determines if additional training epochs are to be performed. For example, the processor can determine that additional training epochs are to be performed if the training has not converged towards a minimum error such that the model accuracy is not improved or is not improved to a particular degree. If so, the process 400 moves back to block 404. If not, the process 400 moves to block 414.

At block 414, the processor derives final weights based on learned optimal bit assignments. In some embodiments, the processor obtains a set of bit assignments that are close to optimal. Also, in some embodiments, the processor can randomly initialize weights of the inner training network 302 based on current bit assignments and train the inner network using the randomly initialized weights. At block 416, the processor outputs the optimized bit assignments and weight matrices obtained during the training process 400. The process 400 ends at block 418.

Although FIG. 4 illustrates one example of a model architecture training process 400, various changes may be made to FIG. 4. For example, while shown as a series of steps, various steps in FIG. 4 can overlap, occur in parallel, occur in a different order, or occur any number of times.

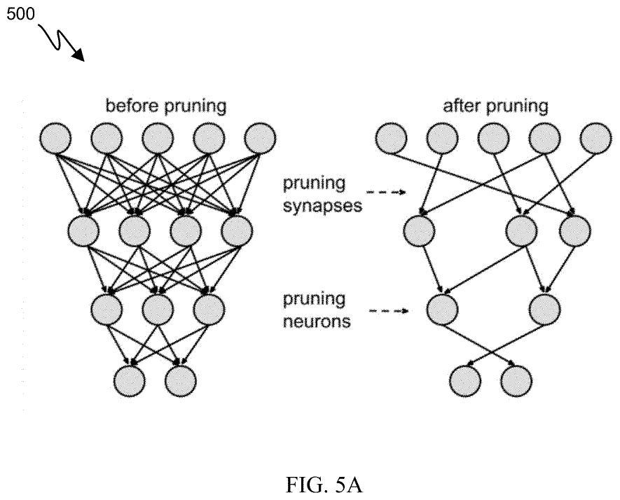

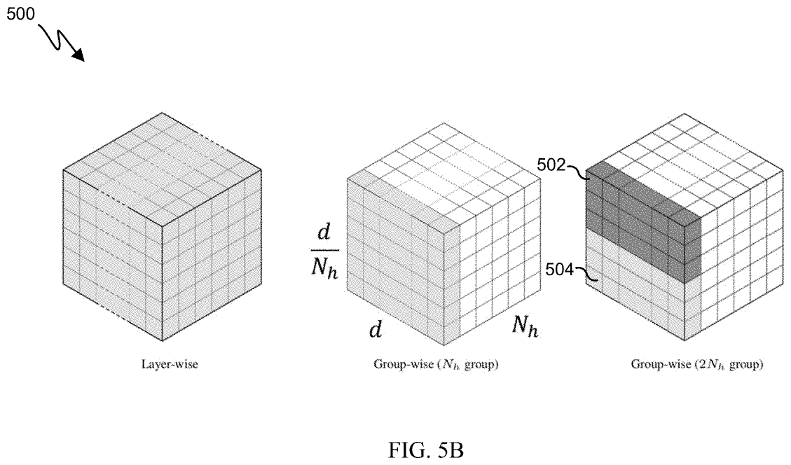

FIGS. 5A and 5B illustrate an example quantization and pruning process 500 in accordance with various embodiments of this disclosure. For ease of explanation, the process 500 may be described as being executed or otherwise used by the processor(s) of any of the electronic devices 101, 102, 104 or the server 106 in FIG. 1. However, the process 500 may be used by any suitable device(s) and in any suitable system(s).

As shown in FIG. 5A, pruning a machine learning model includes pruning synapses and/or neurons from the model. In some embodiments, pruning can be performed randomly. In other embodiments, pruning can be performed in an orderly manner, such as based on a particular quantization bit as described in the various embodiments of this disclosure. For example, if a particular quantization bit is determined to be less accurate for a particular path or edge of the model, the path or edge of the model associated with that less accurate quantization bit can be pruned from the model to increase inference speed and reduce the size of the model. In particular embodiments, pruning includes changing the weights for the portions of the model to be pruned to zeros.

Quantization includes creating a mapping between floating point parameter values in a model, such as floating point weight values, with quantized integers. This effectively replaces the floating point parameter values with integer values. Performing calculations using integer values instead of floating point values is less calculation intensive, increasing inference speeds. Integer values also use less storage in memory than floating point values, resulting in a smaller model for on-device storage and execution. In some embodiments, mapping floating point values with quantized integers to provide integer values for replacing the floating point values can be achieved using Equations (7) and (8). This can also be defined by an affine mapping, such as the following:

real_value=scale*(quantized_value−zero_point) (15)

where real value is the floating point value, quantized value is the associated integer value, and scale and zero_point are constants used as quantization parameters. In some embodiments, the scale value is an arbitrary positive real number and is represented as a floating point value. The zero_point value is an integer, like the quantized values, and is the quantized value corresponding to the real value of 0. These values shift and scale the real floating point values to a set of quantized integer values.

As illustrated in FIG. 5B, quantization and pruning can be performed on groups of model parameters, such as weights of the model parameters. For small convolutional filters, such as 3×3 filters, each filter can have a uniform scale and zero point. However, for larger filters or matrices, such as those found in transformer-based models, using uniform scale can result in large quantization errors. Thus, as illustrated in FIG. 5B, the matrix can be split into several subgroups, each with its own scale and zero point, which greatly reduces the error. In some embodiments, the matrix or filter can be split across either the first dimension or the second dimension. For example, a large 3072×768 matrix or filter can be split into 768 groups across the second dimension or, as shown in FIG. 5B, across the first dimension. Also, a group can be further split into two subgroups, such as by splitting the first dimension in half as shown in FIG. 5B, to provide up to 768×2 groups, for instance. Generally, using more groups can reduce the quantization error but can also result in longer inference time. As described in the various embodiments of this disclosure, during training, groups can be scaled to different bits in order to find the bit providing the most accuracy or the bit providing the highest balance between accuracy or error, model size, and/or inference speed.

Existing approaches typically perform quantization and pruning as separate steps. The various embodiments of this disclosure provide for group quantization and architecture searching to determine which paths or edges of the neural network or model to use during inferences. Pruning can therefore be performed on less important or less accurate portions of the model. The various embodiments of this disclosure allow for performing quantization and pruning simultaneously in optimizing the model, providing end-to-end optimization for a model. For example, as shown in FIG. 5B, a quantized subgroup 502 can be pruned from a group, such as by using zero bit quantization, effectively zeroing out the parameters or weights of the quantized subgroup 502 and leaving a quantized subgroup 504 for use in performing inferences using the model. Since the model parameters can be known prior to deployment, the model can be optimized using quantization, architecture searching, and pruning prior to deployment.

Although FIGS. 5A and 5B illustrate one example of a quantization and pruning process 500, various changes may be made to FIGS. 5A and 5B. For example, groups can be split in any desired dimension(s) of the model parameters. Also, during pruning, particular synapses, neurons, or both can be pruned to reduce the size and complexity of the model. Further, parameters subgroups can be pruned from the model or entire groups can be pruned from the model depending on the results of the architecture searching. In addition, model architectures can come in a wide variety of configurations, and FIGS. 5A and 5B do not limit the scope of this disclosure to any particular configuration or methods for performing quantization and pruning on such model architectures.

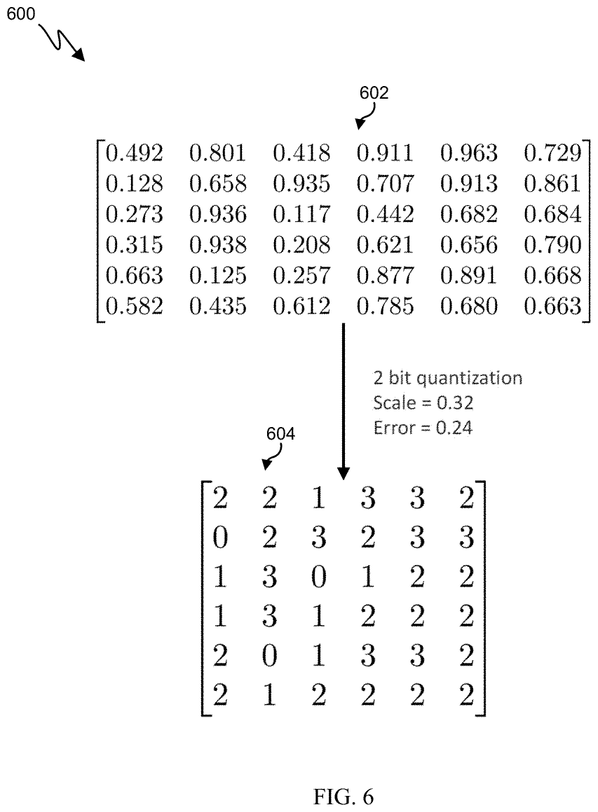

FIG. 6 illustrates an example two-bit quantization method 600 in accordance with various embodiments of this disclosure. For ease of explanation, the method 600 may be described as being executed or otherwise used by the processor(s) of any of the electronic devices 101, 102, 104 or the server 106 in FIG. 1. However, the method 600 may be used by any suitable device(s) and in any suitable system(s).

As described in the various embodiments of this disclosure, quantization includes creating a mapping between floating point parameter values in a model, such as floating point weight values, with quantized integers, effectively replacing the floating point parameter values with integer values to optimize the model. Performing calculations using an optimized low-bit architecture using integer values instead of floating point values is less calculation intensive, increasing inference speeds. Integer values also use less storage in memory than floating point values, resulting in a smaller model for on-device storage and execution.

Mapping the floating point values with the quantized integers to provide integer values for replacing the floating point values can be achieved using one or more of Equations (7), (8), and (15). In the example of FIG. 6, a group 602 of model parameters, such as weights, includes a plurality of floating point values. The processor can split the group 602 of model parameters from a complete set of model parameters, and multiple groups having different parameter values can be quantized as shown in FIG. 6. Here, the group 602 of model parameters are mapped to integer values using a scale of 0.32, creating a quantized parameter group 604 including a plurality of integer values. In this example, the quantization error is 0.24. Using two-bit quantization provides for a greatly reduced model size.

Although FIG. 6 illustrates one example of a two-bit quantization method 600, various changes may be made to FIG. 6. For example, the scale and error shown in FIG. 6 are examples, and other values can be used or achieved. Also, any number of model parameters can be used. Further, other bit values can be used for quantization, such as six-bit, sixteen-bit, 32-bit, etc. In addition, model parameters can come in a wide variety of configurations, and FIG. 6 does not limit the scope of this disclosure to any particular configuration of model parameters or processes for creating quantized values from the model parameters.

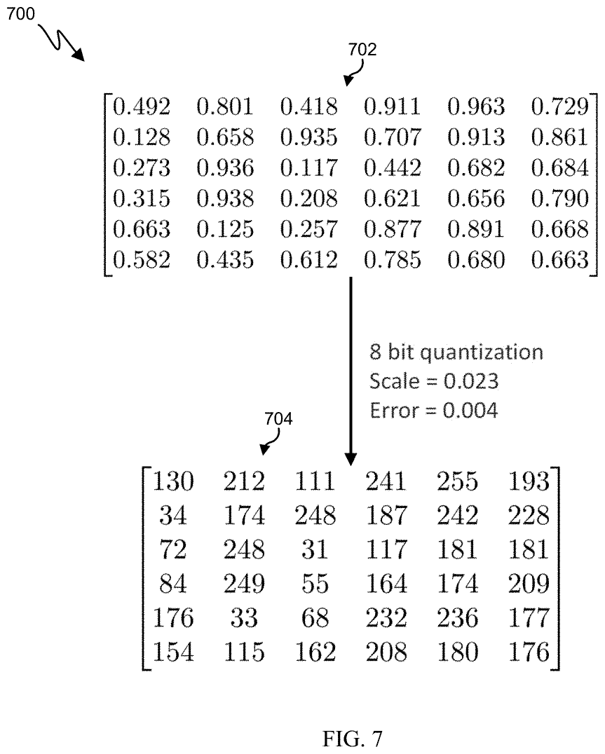

FIG. 7 illustrates an example eight-bit quantization method 700 in accordance with various embodiments of this disclosure. For ease of explanation, the method 700 may be described as being executed or otherwise used by the processor(s) of any of the electronic devices 101, 102, 104 or the server 106 in FIG. 1. However, the method 700 may be used by any suitable device(s) and in any suitable system(s).

Again, mapping the floating point values with the quantized integers to provide integer values for replacing the floating point values can be achieved using one or more of Equations (7), (8), and (15). In the example of FIG. 7, a group 702 of model parameters, such as weights, includes a plurality of floating point values. The processor can split the group 702 of model parameters from a complete set of model parameters, and multiple groups having different parameter values can be quantized as shown in FIG. 7. Here, the processor maps the group 702 of model parameters to integer values using a scale of 0.023, creating a quantized parameter group 704 including a plurality of integer values. In this example, the quantization error is 0.004. As described with respect to FIG. 6, using two-bit quantization provides for a greatly reduced model size. The size of the quantized parameters provided by using two-bit quantization is ¼ the size of using eight-bit quantization, but the error when using two-bit quantization can be much larger than when using eight-bit quantization. Using eight-bit quantization as illustrated in FIG. 7 therefore provides increased accuracy and a larger model size.

Although FIG. 7 illustrates one example eight-bit quantization method 700, various changes may be made to FIG. 7. For example, the scale and error shown in FIG. 7 are examples, and other values can be used or achieved. Also, any number of model parameters can be used. Further, other bit values can be used for quantization, such as six-bit, sixteen-bit, 32-bit, etc. In addition, model parameters can come in a wide variety of configurations, and FIG. 7 does not limit the scope of this disclosure to any particular configuration of model parameters or processes for creating quantized values from the model parameters.

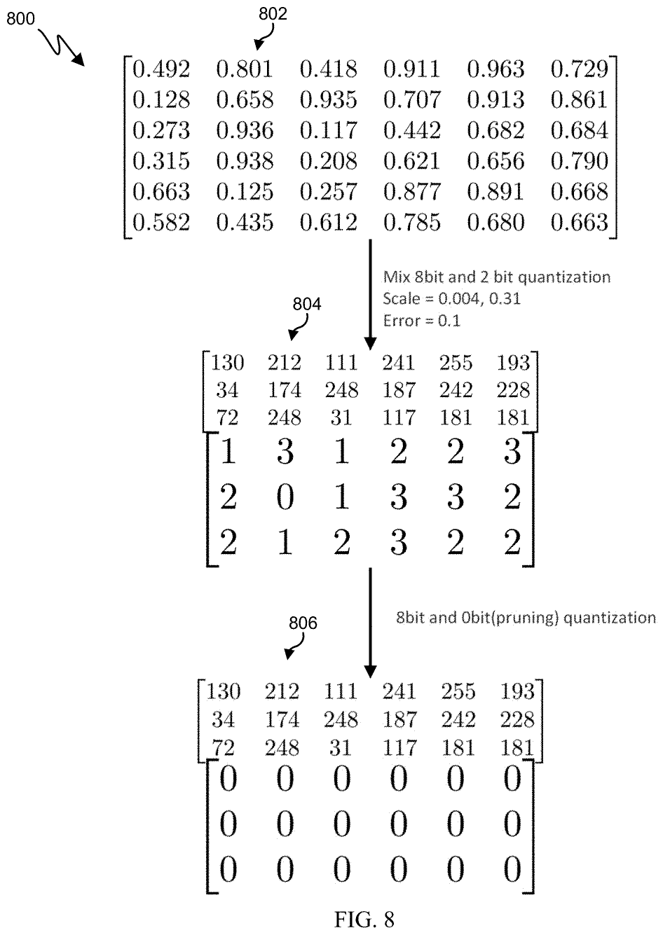

FIG. 8 illustrates an example mixed bit quantization and pruning method 800 in accordance with various embodiments of this disclosure. For ease of explanation, the method 800 may be described as being executed or otherwise used by the processor(s) of any of the electronic devices 101, 102, 104 or the server 106 in FIG. 1. However, the method 800 may be used by any suitable device(s) and in any suitable system(s).

Once again, mapping the floating point values with the quantized integers to provide integer values for replacing the floating point values can be achieved using one or more of Equations (7), (8), and (15). In the example of FIG. 8, a group 802 of model parameters, such as weights, includes a plurality of floating point values. The processor can split the group 802 of model parameters from a complete set of model parameters, and multiple groups having different parameter values can be quantized as shown in FIG. 8. In this example, the processor further splits the group 802 of model parameters into subgroups for mapping the subgroups according to different quantization bit values. In this particular example, the processor maps one subgroup of floating point values from the group 802 using eight-bit quantization and using a scale of 0.004, and the processor maps another subgroup of floating point values from the group 802 using two-bit quantization and using a scale of 0.31. This creates a mixed bit quantized parameter group 804 including a plurality of integer values.

In this example, the quantization error is 0.1. As described with respect to FIGS. 6 and 7, using two-bit quantization provides for a greatly reduced model size. The size of the quantized parameters provided by using two-bit quantization is ¼ the size of using eight-bit quantization, but the error when using two-bit quantization can be much larger than when using eight-bit quantization. Using eight-bit quantization as illustrated in FIG. 7 provides increased accuracy and a larger model size. Using mixed bit quantization as illustrated in FIG. 8 strikes a balance between model size and accuracy, as the model size when using mixed bit quantization is less than the resulting model size when using eight-bit quantization as shown in the example of FIG. 7 and is greater than when using two-bit quantization as shown in the example of FIG. 6. Moreover, the error when using mixed bit quantization can lie between the respective errors when using full two-bit quantization and full eight-bit quantization.

In some embodiments, the various embodiments of this disclosure provide for performing architecture searching to determine which paths or edges of the model best meet the efficiency requirements of an electronic device. As a result of this determination, the subgroups chosen for use with each bit value in mixed bit quantization can be prioritized based on the efficiency requirements. For example, based on the result of the architecture search, the processor can use eight-bit quantization on the more important or more accurate portion(s) of the parameters and two-bit quantization on the less important or less accurate portion(s) of the parameters. Additionally, based on the result of the architecture search, the processor can prune the less important or less accurate portion(s) of the parameters from the group. For example, as illustrated in FIG. 8, the processor prunes the two-bit integer values from the mixed bit quantized parameter group 804, creating a quantized and pruned group 806 having eight-bit integer values and zeroes replacing the previous two-bit values. Pruning values from the quantized parameter group further reduces the model size and further reduces inference time.

Although FIG. 8 illustrates one example eight-bit quantization method 800, various changes may be made to FIG. 8. For example, the scale and error shown in FIG. 8 are examples, and other values can be used or achieved. Also, any number of model parameters can be used. Further, other bit values can be used for quantization, such as six-bit, sixteen-bit, 32-bit, etc. Moreover, mixed quantization can use any number of different bit values, such as three or more different bit values. Beyond that, when using mixed quantization, parameters can be split into subgroups having differing amounts of parameters, such as assigning ⅓ of the parameters from the main group to a subgroup and assigning the other ⅔ of the parameters from the main group to another subgroup. In addition, model parameters can come in a wide variety of configurations, and FIG. 8 does not limit the scope of this disclosure to any particular configuration of model parameters or processes for creating quantized values from the model parameters.

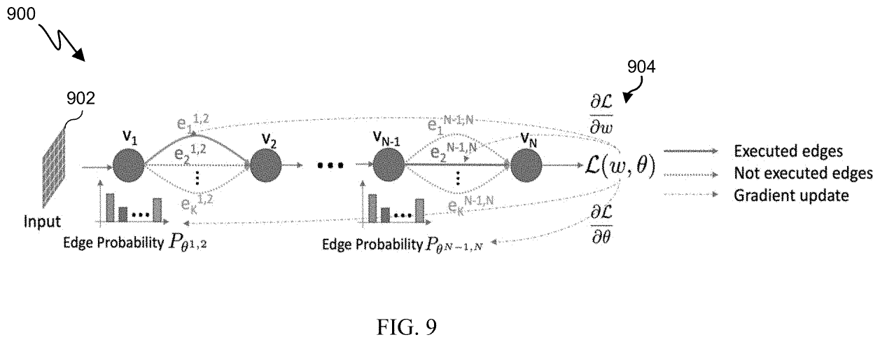

FIG. 9 illustrates an architecture searching model 900 in accordance with various embodiments of this disclosure. For ease of explanation, the model 900 may be described as being executed or otherwise used by the processor(s) of any of the electronic devices 101, 102, 104 or the server 106 in FIG. 1. However, the model 900 may be used by any suitable device(s) and in any suitable system(s).

During training and/or optimization of the model 900, the processor receives inputs 902 into the model. The processor, using the model 900, splits a set of model parameters such as weights into groups, and different paths are used for different quantization bits for each group and for each layer. As illustrated in FIG. 9, the model 900 includes nodes Vi to VN that each include edges ei to ek, where each edge between layers is one group of layers using a specific quantization bit. The processor uses back propagation and a loss function 904 to determine edge probabilities P_{θ1,2} to P_{θN-1,N} for each edge between each node and to choose which bit to use for each layer and each group or subgroup of model parameters. Based on the calculated loss, a gradient can be determined and used during back propagation to update the edge probabilities P.

One possible objective of the model optimization is to minimize the final error according to weight Wₐ and selected path a, where the selected path a represents one possible architecture to choose for use during runtime inferences after optimization and deployment of the model 900. The loss function to achieve this objective can be as follows:

$${min}_{a ∈ A} {min}_{{w}_{a}} ℒ ( a , {w}_{a} ) \qquad ( 16 )$$

For edges between two nodes, architecture a can be represented by weight mₖ^{ij}, where Σₖmₖ^{ij}=1 (meaning the sum of the probability of choosing each path is 1). The processor can sum the edges between two nodes, where the output is the weight average that can be expressed as follows:

$${v}_{j} = {Σ}_{i , k} {m}_{k}^{ij} ( {v}_{i} ; {w}_{k}^{ij} ) \qquad ( 17 )$$

where vᵢ is the input to the layer and vⱼ is the weighted average output. In some embodiments, paths or edges that are not selected can be pruned from the model to further decrease the size and increase the speed of the model.

In some embodiments, because of the fully back propagating nature of the model 900, one or more constraints can be added into the loss function such as a size constraint, an accuracy constraint, and/or an inference speed constraint. The one or more constraints used can depend on particular deployment device characteristics. For example, if the deployment device is a traditional computing device having large memory storage available, the size constraint may not be used. If the deployment device is a wearable device with more limited memory, the size constraint can be used so that the processor using the model 900 can automatically select parameters based on the size constraint or other customized constraints. As a particular example, a loss function with an added size constraint and inference speed constraint might be expressed as follows:

$${min}_{a ∈ A} {min}_{{w}_{a}} ℒ ( a , {w}_{a} ) + {ℒ}_{size} + {ℒ}_{FLOPs} \qquad ( 18 )$$

where size is the memory that the model occupies and FLOPs is the measurement of how many calculations are needed for an inference. In this way, the model 900 can meet the specific constraints for model size and inference speed while maintaining a best possible accuracy.

In some embodiments, the constraints can be prioritized. For example, the size of the model 900 can be constrained and prioritized with respect to the accuracy of the model. As a particular example, if size is less important for a particular deployment device that is able to store a larger model, the accuracy of the model can be emphasized over the size, such as in the following manner:

$${min}_{a ∈ A} {min}_{{w}_{a}} 5 {ℒ}_{acc} ( a , {w}_{a} ) + {ℒ}_{size} ( a ) \qquad ( 19 )$$

where L_{acc} is the standard cross-entropy loss reflecting the final accuracy. The loss function is therefore modified to prioritize accuracy over size. In particular embodiments, the weight can be set to 10 or other larger value if a constraint is highly important, and the weight can be set to 0 or other lower value if the constraint is unimportant. As another example, if having a smaller sized model is more important for a device, the size constraint can be prioritized over accuracy, such as in the following manner:

$${min}_{a ∈ A} {min}_{{w}_{a}} 2 {ℒ}_{acc} ( a , {w}_{a} ) + 6 {ℒ}_{size} ( a ) \qquad ( 20 )$$

In some embodiments, during inferences, instead of summing all possibilities, the processor may select the path having the highest probability. For example, selecting the path having the highest probability can be performed as follows:

$${P}_{{θ}^{ij}} ( {m}_{k}^{ij} = 1 ) = softmax ( {θ}_{k}^{ij} / t \vert {θ}^{ij} / t ) = \frac{exp ( {θ}_{k}^{ij} / t )}{{Σ}_{k = 1}^{{K}^{ij}} exp ( {θ}_{k}^{ij} / t )} \qquad ( 21 )$$

where θₖ^{ij} is the parameter of the searched parameter and normalized based on the softmax function with a temperature t. In particular embodiments, t may be chosen to be large at the beginning of training to better learn the parameters and may be gradually reduced to zero, as it will approximate the situation during inferencing so the training will converge to the inference cases. Here, the inference can be deterministic on edges. In some cases, the inference can feed into low-precision matrix multiplication libraries, such as GEMMLOP or CUTLASS, to further improve inference speeds and memory usage.

Although FIG. 9 illustrates one example of an architecture searching model 900, various changes may be made to FIG. 9. For example, the loss parameters can be altered based on constraints to be used as described in this disclosure. Also, the model 900 can include any number of nodes and any number of edges between the nodes. Further, it will be understood that the weights of the constraints in Equations (19) and (20) can be weighted in any combination of size, accuracy, and inference speed as determined for a particular deployment device. In addition, model architectures can come in a wide variety of configurations, and FIG. 9 does not limit the scope of this disclosure to any particular configuration of a machine learning model.

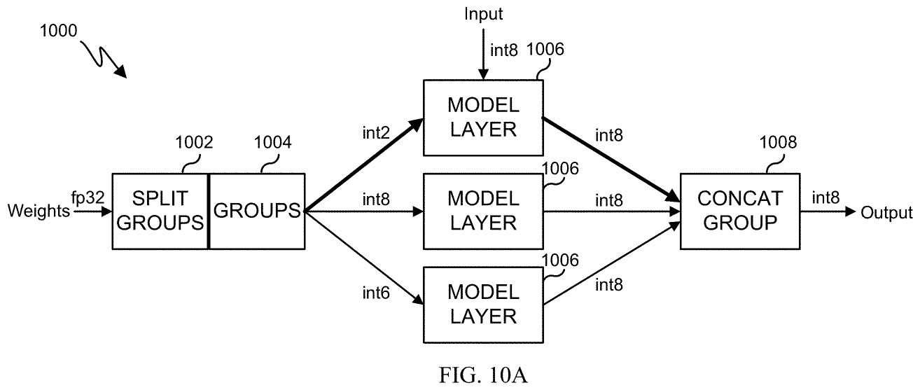

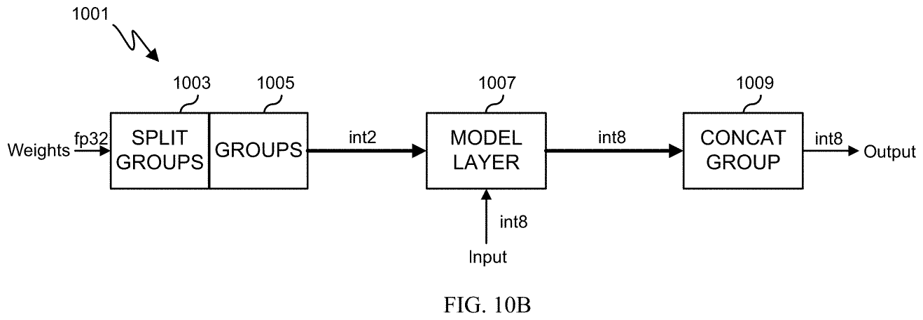

FIGS. 10A and 10B illustrate an example quantization and architecture searching and training process 1000 and an example trained model inference process 1001 in accordance with various embodiments of this disclosure. For ease of explanation, the processes 1000 and 1001 may be described as being executed or otherwise used by the processor(s) of any of the electronic devices 101, 102, 104 or the server 106 in FIG. 1. However, the processes 1000 and 1001 may be used by any suitable device(s) and in any suitable system(s).

As shown in FIG. 10A, the process 1000 includes training and optimizing a model by quantizing model parameters. This is done by mapping the model parameters to integer values using different quantization bit values, applying the quantized model parameters to an input (such as an input vector), and determining which quantization bit value best meets the requirements of the electronic device. At block 1002, the processor splits a set of model parameters such as weights into groups. As described in the various embodiments of this disclosure, the model parameters can be split into groups in various ways, such as by splitting a weight matrix across at least one of the first dimension or the second dimension. As also described in the various embodiments of this disclosure, the split groups can be further split into subgroups.

At block 1004, for each of the split groups, the processor quantizes the group according to different quantization bit values. For example, as shown in FIG. 10A, the groups are quantized using two-bit, six-bit, and eight-bit values. According to the various embodiments of this disclosure, quantizing the model parameters for each of the different quantization bit values can include using different scales and zero-point values for different quantization bit values. During training and optimization, the processor, for each layer of the machine learning model, quantizes the model parameters associated with each respective layer of the machine learning model in order to determine which path for each layer to select as best fulfilling the constraints of the deployment device.

As an example of this, as shown in FIG. 10A, different paths for each of the quantization bit values are provided for the same model layer 1006 in order to apply the quantized weights to the inputs for the model layer 1006. In some embodiments, the model layer 1006 can be a fully connected layer, depending on the type of model. The outputs of the different quantized weights as applied to the inputs can be averaged, and the processor can select a quantization bit that most closely meets the constraints of the deployment device. In some embodiments, as shown in FIG. 10A at block 1008, the processor aggregates the outputs of the model layer 1006 for each of the quantization bit paths, such as the outputs of matrix multiplications performed on the inputs and each of the quantized weight groups, as eight-bit values and outputs the result for the layer. Selecting the inference path that most meets the constraints of the deployment device can include determining probabilities for each inference path or edge of each layer of the machine learning model based on using a final error and back propagation as described in the various embodiments of this disclosure to select the quantization bit to use for a particular layer and a subgroup for that layer during inference or deployment runtime of the model. In the example illustrated in FIG. 10A, the processor determines, using the model, that two-bit quantization provides the most accurate result or provides the result that most meets the constraints of the electronic device.

As illustrated in FIG. 10A, this process 1000 is performed for each group split from the model parameters for the particular layer. It will be understood that the process 1000 can be performed for each layer of the machine learning model in order to select a best inference path for each layer of the machine learning model.

As shown in FIG. 10B, the processor performs the process 1001 using an optimized and deployed model, such as the model 900 optimized using the process 1000. At block 1003, the processor splits a set of model parameters such as weights into groups. As described in the various embodiments of this disclosure, the model parameters can be split into groups in various ways, such as by splitting a weight matrix across at least one of the first dimension or the second dimension. As also described in the various embodiments of this disclosure, the split groups can be further split into subgroups.

At block 1005, for each of the split groups, the processor quantizes the group according to a particular quantization bit value for a selected path determined during optimization. For example, as described with respect to FIGS. 9 and 10A, an edge associated with a particular quantization bit for each of the model layers can be selected as providing the best results during optimization based on architecture searching processes and priority constraints. In the example of FIG. 10A, for the particular group for a particular model layer, two-bit quantization was selected during optimization. In the example of FIG. 10B, during inferencing the two-bit path is used for a model layer 1007 for processing an inference request and ultimately generating an inference result.

It will be understood that each layer of the model can have different selected paths. For example, the next layer of the model after the layer illustrated in FIG. 10B may have a selected path associated with eight-bit quantization. It will also be understood that each split group for a particular layer can use a particular quantization bit value. For example, although the selected path for a model parameter group for layer 1007 shown in FIG. 10B is associated with two-bit quantization, another group for layer 1007 may be associated with a different quantization bit value as determined during optimization. In some embodiments, the model layer 1007 can be a fully connected layer, depending on the type of model.

At block 1009, the processor aggregates the outputs of the model layer from model layer 1007, such as the outputs of matrix multiplications performed on the inputs and each of the quantized weight groups, as eight-bit values. The processor also outputs the result for the layer 1007. As illustrated in FIG. 10B, this process 1001 is performed for each group split from the model parameters for the particular layer. It will be understood that the process 1001 can be performed for each layer of the machine learning model in order to provide an inference result using the selected best inference paths or edges for each layer of the machine learning model.

Although FIGS. 10A and 10B illustrate one example of a quantization and architecture searching and training process 1000 and one example of a trained model inference process 1001, various changes may be made to FIGS. 10A and 10B. For example, other bit values can be used for quantization, such as sixteen-bit, 32-bit, etc. Also, mixed quantization can be used. Further, bit values other than eight-bit values can be used for the layer output. Moreover, it will be understood that the selection of two-bit quantization is but one example, and other quantization bit values can be chosen for each group for each layer of the model. In addition, model architectures can come in a wide variety of configurations, and FIGS. 10A and 10B do not limit the scope of this disclosure to any particular configuration of a machine learning model.

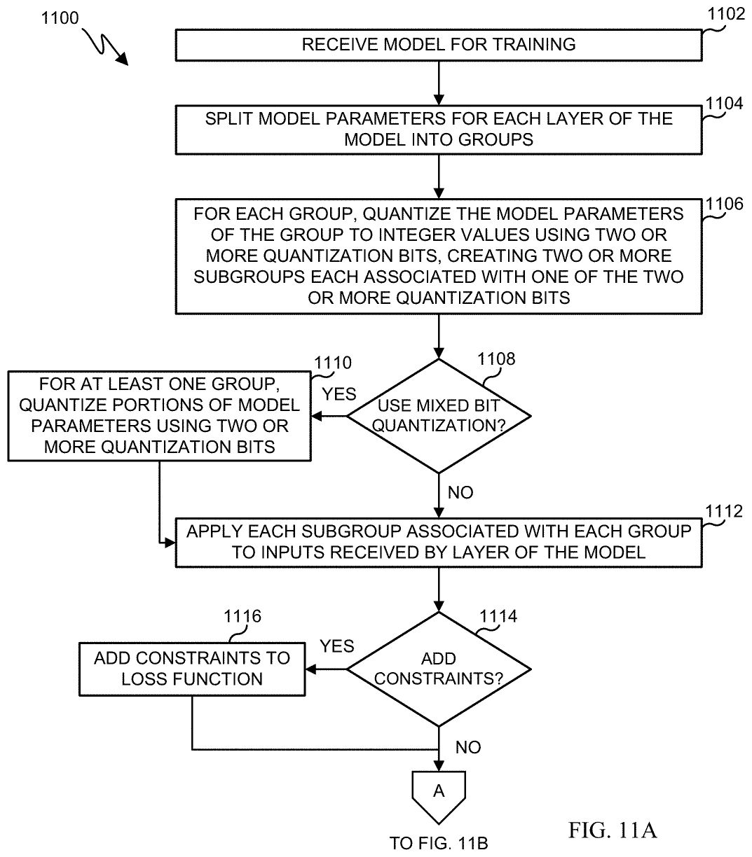

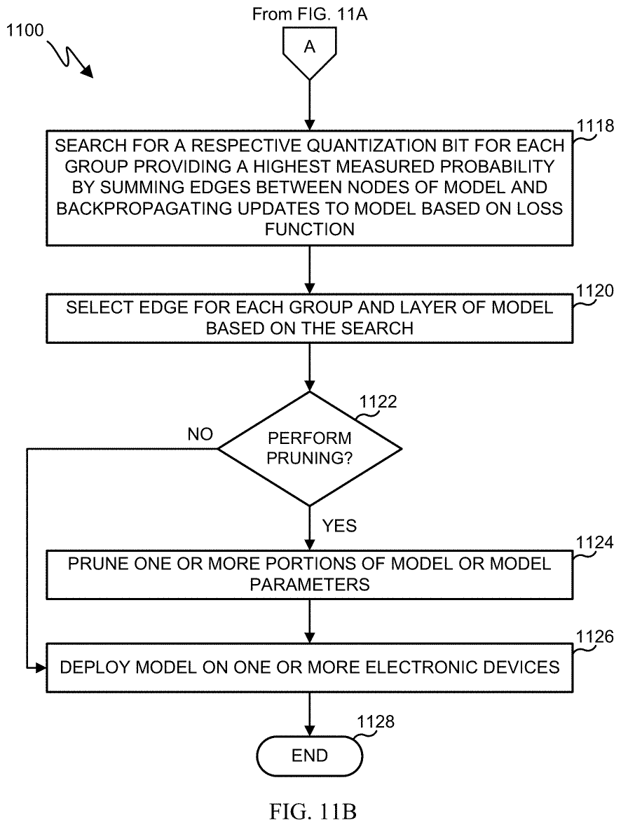

FIGS. 11A and 11B illustrate an example model training process 1100 in accordance with various embodiments of this disclosure. For ease of explanation, the process 1100 may be described as being executed or otherwise used by the processor(s) of any of the electronic devices 101, 102, 104 or the server 106 in FIG. 1. However, the process 1100 may be used by any suitable device(s) and in any suitable system(s).

At block 1102, the processor receives a model for training, such as the pretrained model 202. At block 1104, the processor splits the model parameters for each layer of the model into groups of model parameters in accordance with the various embodiments of this disclosure. For example, for a particular layer of the model, the weights of the model layer can be split into a plurality of groups of weights, such as by splitting the weight matrix across at least one of the first dimension or the second dimension. At block 1106, for each group, the processor quantizes the model parameters of the group to integer values using two or more quantization bits. This creates two or more subgroups from each group, where each subgroup is associated with one of the two or more quantization bits. For example, the processor can quantize a group into two-bit, six-bit, and eight-bit subgroups. In some embodiments, each subgroup created from a group has a same number of parameters as the group, except the parameters of the subgroups are integer values mapped with floating point values in the group based on the particular quantization bit for the subgroup.

At decision block 1108, the processor determines whether to use mixed-bit quantization. If so, the process 1100 moves to block 1110. At block 1110, for at least one of the groups, the processor quantizes portions of the model parameters of the group using two or more quantization bits, such as is shown in FIG. 6. For example, half of the floating point values in a group can be quantized using two-bit quantization, and half of the floating point values in the group can be quantized using eight-bit quantization. In some embodiments, three or more quantization bits can be used. The process 1100 then moves to block 1112. If the processor determines not to use mixed bit quantization at decision block 1108, the process 1100 moves to block 1112.

At block 1112, the processor applies each subgroup created in block 1106 and/or 1110 to inputs received by a layer of the model. In some embodiments, the outputs created by applying the weights of the subgroups for a group to the inputs are output as a specific bit value type, such as eight-bit, as described with respect to FIG. 10A. Also, the outputs from each of the subgroups created using the different quantization bits can be aggregated or concatenated and provided as inputs for a next layer of the model. It will be understood that each layer of the model can receive the outputs from a previous layer as inputs and that parameters for each layer can be split into groups, quantized into subgroups, and applied to the inputs received from the previous layer.

At decision block 1114, the processor determines if constraints are to be added to further train the model based on specific constraints, such as model size, accuracy, and/or inference speed. If so, at block 1116, the processor adds the constraints to a loss function, such as in the same or similar manner as the examples of Equations (19) and (20). The process 1100 then moves to block 1118. If the processor determines that no constraints are to be added at decision block 1114, the process moves from decision block 1114 to block 1118. At block 1118, the processor searches for the respective quantization bit for each group providing a highest measured probability, such as by summing edges between nodes of the model and back propagating updates to the model based on a loss function. If constraints were added to the loss function at block 1116, the loss function includes such customized constraints. In some embodiments, updating the model during back propagation includes determining a gradient using the loss function and updating model path parameters with the gradient by summing a probability weight with the gradient to create a new or updated weight.

At block 1120, the processor selects an edge for each group for each layer of the model based on the search performed in block 1118. The selected edges represent a selected model architecture for use during runtime to process inference requests received by the processor. At decision block 1122, the processor determines whether to perform pruning on the model. If not, the process 1100 moves to block 1126. If so, the process 1100 moves to block 1124. At block 1124, the processor performs pruning on the model to prune one or more portions of the model or model parameters from the model, further reducing the size of the model and number of calculations performed by the model. For example, if certain edges or paths are not chosen in block 1120, the processor can prune one or more of these edges or paths from the model. As another example, if mixed bit quantization is used and the processor determines using the model that a portion of the parameters for a group that is quantized using a particular bit during mix bit quantization has a minimal impact on accuracy, the portion of the parameters can be pruned by replacing the parameters using zero-bit quantization, such as is shown in FIG. 6. The process 1100 then moves to block 1126. At block 1126, the processor deploys the model on one or more electronic devices, such as by transmitting the model to a remote electronic device. The process 1100 ends at block 1128.

Although FIGS. 11A and 11B illustrate one example of a model training process 1100, various changes may be made to FIGS. 11A and 11B. For example, while shown as a series of steps, various steps in FIGS. 11A and 11B can overlap, occur in parallel, occur in a different order, or occur any number of times. As a particular example, performing mixed bit quantization can occur later in the process 1100 after block 1118 if desired. For instance, if the processor training the model determines at block 1118 that using a first quantization bit, such as two-bit, results in a smaller model size and fast inference processing but has high error while a second quantization bit, such as eight-bit, results in lower error but has a larger model size and lower inference speed, the processor can apply mixed bit quantization. As another particular example, pruning at blocks 1122 and 1124 can be performed earlier, such as during blocks 1106 or 1110, which may allow for pruning of parameters that are determined to provide less accurate results. Also, in some embodiments, the same electronic device that trains the model can use the model, and therefore the processor can deploy the model locally on the same device.

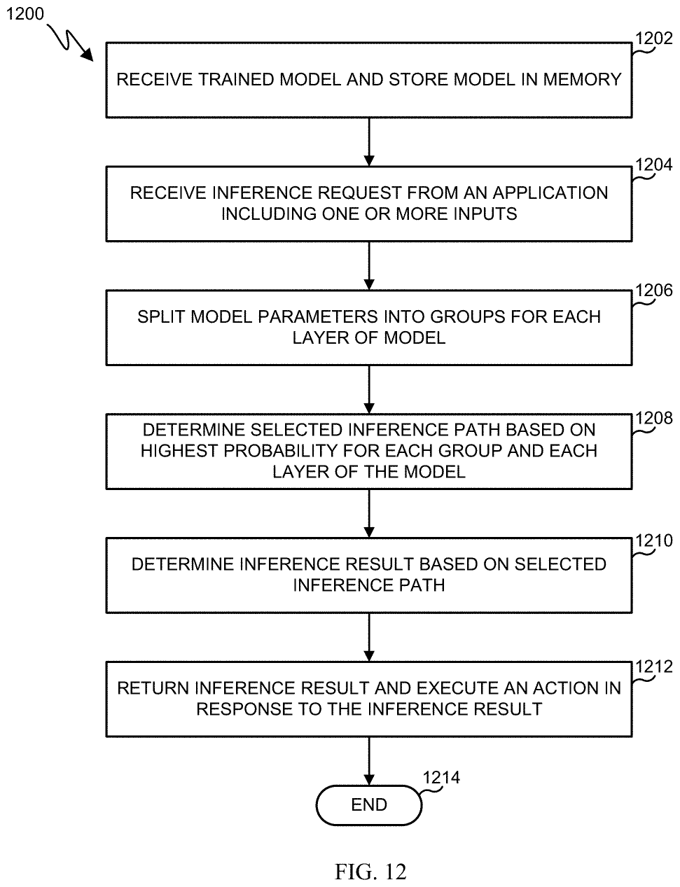

FIG. 12 illustrates an example model inference process 1200 in accordance with various embodiments of this disclosure. For ease of explanation, the process 1200 may be described as being executed or otherwise used by the processor(s) of any of the electronic devices 101, 102, 104 or the server 106 in FIG. 1. However, the process 1200 may be used by any suitable device(s) and in any suitable system(s).

At block 1202, the processor receives a trained model and stores the model in memory, such as the memory 130. The model can be trained as described in the various embodiments of this disclosure, such as those described with respect to FIGS. 9, 10A, 11A, and 11B. At block 1204, the processor receives an inference request from an application, where the inference request includes one or more inputs. At block 1206, the processor splits the parameters of the model received at block 1202 into groups for each layer of the model. At block 1208, the processor determines a selected inference path based on a highest probability for each group and each layer of the model. For example, for each group at each layer, the processor can select between edges or paths of the model associated with particular quantization bits and select the path and quantization bit that have the highest probability. The groups split at block 1206 can be quantized using the selected path and quantization bit for each particular group at each layer of the model. A complete path for the model is therefore used, defining an architecture for the model.

At block 1210, the processor determines an inference result based on the selected inference path of the model. At block 1212, the processor returns an inference result and executes an action in response to the inference result. For example, the inference result could identify an utterance for an NLU task, and an action can be executed based on the identified utterance, such as creating a text message, booking a flight, or performing a search using an Internet search engine. As another example, the inference result could be a label for an image pertaining to the content of the image, and the action can be presenting to the user a message indicating a subject of the image, such as a person, an animal, or other labels. After executing the action in response to the inference result, the process 1200 ends at block 1214.

Although FIG. 12 illustrates one example of a model training process 1200, various changes may be made to FIG. 12. For example, while shown as a series of steps, various steps in FIG. 12 can overlap, occur in parallel, occur in a different order, or occur any number of times. Also, in some embodiments, block 1206 may not be performed, such as if (during training and optimization) split parameter groups are stored for use during deployment and therefore the parameters do not need to be split when processing an inference request using the trained model. Further, block 1208 may not be performed if inference paths are determined prior to receiving the inference request, such as during training and optimization of the model. In addition, certain paths or parameters of the model can be pruned from the model, and therefore such paths or parameters in effect are not considered during the process 1200.

Although this disclosure has been described with example embodiments, various changes and modifications may be suggested to one skilled in the art. It is intended that this disclosure encompass such changes and modifications as fall within the scope of the appended claims.

What is claimed is:

1. A machine learning method using a trained machine learning model residing on an electronic device, the method comprising:
receiving an inference request by the electronic device;
determining, using the trained machine learning model, an inference result for the inference request using a selected inference path in the trained machine learning model, wherein:
the selected inference path is selected based on a highest probability for each layer of the trained machine learning model; and
a size of the trained machine learning model is reduced corresponding to constraints imposed by the electronic device; and
executing an action in response to the inference result.

2. The method of claim 1, wherein:
the size of the trained machine learning model is reduced by training a model; and
training the model comprises:
splitting parameters of the model into groups, wherein each group is associated with a layer of the model, wherein the parameters include floating point values; and
for each group, searching for a respective quantization bit providing a highest measured probability, wherein the quantization bit is used to replace the floating point values of the parameters of the group with integer values.

3. The method of claim 2, wherein:
each respective quantization bit comprises a bit value;
searching for the respective quantization bit comprises performing mixed bit quantization; and
performing the mixed bit quantization comprises:
replacing a portion of the floating point values of the parameters for at least one of the groups with integer values corresponding to a first bit value; and
replacing another portion of the floating point values of the parameters for the at least one of the groups with integer values corresponding to a second bit value.

4. The method of claim 3, wherein performing the mixed bit quantization further comprises:
determining the first bit value and the second bit value based on the searching for the respective quantization bits; and
assigning the first bit value and the second bit value to the portion of the floating point values and the other portion of the floating point values, respectively, based on the highest measured probability.

5. The method of claim 4, wherein the integer values corresponding to the second bit value are zeros.

6. The method of claim 2, wherein the size of the trained machine learning model is further reduced by changing one or more parameters of at least one of the groups into zeros in parallel with searching for the respective quantization bits.

7. The method of claim 2, wherein:
each layer of the model comprises a plurality of edges; and
for each group, searching for the respective quantization bit comprises:
identifying, using back propagation, an edge from among the plurality of edges in one of the layers of the model, wherein the identified edge is associated with the highest probability; and
selecting the identified edge for an associated group, wherein the respective quantization bit comprises a bit value associated with the selected identified edge.

8. The method of claim 1, wherein:
the constraints imposed by the electronic device include at least one of: a size constraint, an inference speed constraint, and an accuracy constraint; and
the constraints are included within a loss function used during training of the trained machine learning model.

9. An electronic device comprising:
at least one memory configured to store a trained machine learning model; and
at least one processor coupled to the at least one memory, the at least one processor configured to:
receive an inference request;
determine, using the trained machine learning model, an inference result for the inference request using a selected inference path in the trained machine learning model, wherein:
the selected inference path is selected based on a highest probability for each layer of the trained machine learning model; and
a size of the trained machine learning model is reduced corresponding to constraints imposed by the electronic device; and
execute an action in response to the inference result.

10. The electronic device of claim 9, wherein:
the size of the trained machine learning model is reduced by training a model; and
to train the model, the at least one processor of the electronic device or another electronic device is configured to:
split parameters of the model into groups, wherein each group is associated with a layer of the model, wherein the parameters include floating point values; and
for each group, search for a respective quantization bit providing a highest measured probability, wherein the quantization bit is used to replace the floating point values of the parameters of the group with integer values.

11. The electronic device of claim 10, wherein:
each respective quantization bit comprises a bit value;
to search for the respective quantization bit, the at least one processor of the electronic device or the other electronic device is configured to perform mixed bit quantization; and
to perform the mixed bit quantization, the at least one processor of the electronic device or the other electronic device is configured to:
replace a portion of the floating point values of the parameters for at least one of the groups with integer values corresponding to a first bit value; and
replace another portion of the floating point values of the parameters for the at least one of the groups with integer values corresponding to a second bit value.

12. The electronic device of claim 11, wherein, to perform the mixed bit quantization, the at least one processor of the electronic device or the other electronic device is configured to:
determine the first bit value and the second bit value based on the searching for the respective quantization bits; and
assign the first bit value and the second bit value to the portion of the floating point values and the other portion of the floating point values, respectively, based on the highest measured probability.

13. The electronic device of claim 12, wherein the integer values corresponding to the second bit value are zeros.

14. The electronic device of claim 10, wherein, to further reduce the size of the trained machine learning model, the at least one processor of the electronic device or the other electronic device is configured to change one or more parameters of at least one of the groups into zeros in parallel with searching for the respective quantization bits.

15. The electronic device of claim 10, wherein:
each layer of the model comprises a plurality of edges; and
to search for the respective quantization bit, the at least one processor of the electronic device or the other electronic device is configured, for each group, to:
identify, using back propagation, an edge from among the plurality of edges in one of the layers of the model, wherein the identified edge is associated with the highest probability; and
select the identified edge for an associated group, wherein the respective quantization bit comprises a bit value associated with the selected identified edge.

16. The electronic device of claim 9, wherein:
the constraints imposed by the electronic device include at least one of: a size constraint, an inference speed constraint, and an accuracy constraint; and
the constraints are included within a loss function used during training of the trained machine learning model.

17. A non-transitory computer readable medium embodying a computer program, the computer program comprising instructions that when executed cause at least one processor of an electronic device to:
receive an inference request;
determine, using a trained machine learning model, an inference result for the inference request using a selected inference path in the trained machine learning model, wherein:
the selected inference path is selected based on a highest probability for each layer of the trained machine learning model; and
a size of the trained machine learning model is reduced corresponding to constraints imposed by the electronic device; and
execute an action in response to the inference result.

18. The non-transitory computer readable medium of claim 17, wherein:
the size of the trained machine learning model is reduced by training a model; and
training the model comprises:
splitting parameters of the model into groups, wherein each group is associated with a layer of the model, wherein the parameters include floating point values; and
for each group, searching for a respective quantization bit providing a highest measured probability, wherein the quantization bit is used to replace the floating point values of the parameters of the group with integer values.

19. The non-transitory computer readable medium of claim 18, wherein:
each respective quantization bit comprises a bit value;
searching for the respective quantization bit comprises performing mixed bit quantization; and
performing the mixed bit quantization comprises:
replacing a portion of the floating point values of the parameters for at least one of the groups with integer values corresponding to a first bit value; and
replacing another portion of the floating point values of the parameters for the at least one of the groups with integer values corresponding to a second bit value.

20. The non-transitory computer readable medium of claim 18, wherein the size of the trained machine learning model is further reduced by changing one or more parameters of at least one of the groups into zeros in parallel with searching for the respective quantization bits.
